(19) United States
(12) Patent Application Publication
(10) Pub. No.: US 2025/0133421 A1
(43) Pub. Date: Apr. 24, 2025

(54) COMPUTING-AWARE TRAFFIC STEERING METHOD, APPARATUS, AND SYSTEM IN MOBILE NETWORK

(71) Applicant: FOUNDATION OF SOONGSIL UNIVERSITY-INDUSTRY COOPERATION, Seoul (KR)

(72) Inventor: Young Han KIM, Seoul (KR)

(73) Assignee: FOUNDATION OF SOONGSIL UNIVERSITY-INDUSTRY COOPERATION, Seoul (KR)

(21) Appl. No.: 18/817,707

(22) Filed: Aug. 28, 2024

(30) Foreign Application Priority Data
Oct. 19, 2023 (KR) 10-2023-0139959

(51) Int. Cl. H04W 24/02; H04L 45/00; H04W 76/10

(52) U.S. Cl. CPC H04W 24/02; H04L 45/566; H04W 76/10

(57) ABSTRACT

The present disclosure discloses a computing-aware traffic steering method, apparatus and system in a mobile network. According to the present disclosure, there is provided a computing-aware traffic steering method of mobile network control plane, the method including: in a case where it is confirmed that there is no target data network access identifier (DNAI) mapped to a service ID when a PDU session establishment request including the service ID of a user terminal (UE) is made, transmitting the service ID and user plane path information to a computing-aware traffic steering mobile user plane controller (CATS-MUP-C) using segment routing; reconfiguring a user plane path for accessing an Anycast IP address corresponding to the service ID in conjunction with the CATS-MUP-C; and completing the PDU session establishment using the Anycast IP address.

### CROSS-REFERENCE TO RELATED APPLICATION

This application claims under 35 U.S.C. § 119 (a) the benefit of Korean Patent Application No. 10-2023-0139959 filed on Oct. 19, 2023, the entire contents of which are incorporated herein by reference.

### BACKGROUND

### (a) Technical Field

The present disclosure relates to a computing-aware traffic steering method, apparatus, and system in a mobile network.

### (b) Background Art

Recently, for better availability, service instances running the same service are deployed simultaneously in multiple geographically distributed edge sites.

In such an environment, in order to satisfy user experience and optimize computing resources, it is necessary to transfer user traffic to the optimal edge site based on both computing and networking information.

An internet engineering task force (IETF) proposed a computing-aware traffic steering (CATS) framework for the above-described processing in general Internet infrastructure.

The CATS framework provides an approach to making computing and networking-aware traffic steering decisions in an environment where services are deployed in multiple locations.

The CATS framework is an overlay framework that dynamically selects a service contact instance suitable for a user's service request by combining computing and networking metrics.

Here, the service contact instance is a service function that is responsible for receiving requests to the instance to connect the requested service to the actual service instance.

However, the networking environment of the CATS framework targets the general Internet, and a method supporting computing-aware traffic steering has not yet been proposed for the mobile network architecture.

### SUMMARY OF THE DISCLOSURE

In order to solve the problems of the above-mentioned prior art, the present disclosure proposes a computing-aware traffic steering method, apparatus, and system capable of dynamically steering user traffic to the optimal service instance in a mobile network.

In order to achieve the above-described objects, according to one embodiment of the present disclosure, there is provided a computing-aware traffic steering method of mobile network control plane, the method including: in a case where it is confirmed that there is no target data network access identifier (DNAI) mapped to a service ID when a packet data unit (PDU) session establishment request including the service ID of a user terminal (UE) is made, transmitting the service ID and user plane path information to a CATS mobile user plane controller (CATS-MUP-C) in a computing-aware traffic steering (CATS) network environment using segment routing; reconfiguring a user plane path for accessing an Anycast IP address corresponding to the service ID in conjunction with the CATS-MUP-C; and completing the PDU session establishment using the Anycast IP address.

The mobile network control plane may be a control plane of a 5G or 6G mobile communication network, and the transmitting may include calling a PDU session create session management (SM) context request to a corresponding session management function (SMF) according to a data network name (DNN) corresponding to the service ID when an access and mobility management function (AMF) of the control plane receives the PDU session establishment request from the UE.

The transmitting may include, after the calling, performing an SM policy association establishment procedure so that the SMF establishes an SM policy association with a policy control function (PCF) in conjunction with unified data repository (UDR) and obtains a default policy and charging control (PCC) rule for the service ID.

The PCC rule may include traffic identification information, target data network access identifier (DNAI) information, and/or N6 traffic routing information.

The transmitting may include, after the performing of the SM policy association establishment procedure, transmitting a SM policy control update request for the service ID to the PCF when the SMF confirms that there is no target DNAI mapped to the service ID by the CATS-MUP-C.

The transmitting may include, after the transmitting of the SM policy control update request, requesting, by the PCF, a new policy of the target DNAI of the PDU session for the service ID to which the user plane path information is attached to a network exposure function (NEF).

The transmitting may include, after the requesting of a new policy of the target DNAI of the PDU session, transmitting, by the NEF, the service ID to the CATS-MUP-C.

The reconfiguring of the user plane path may include receiving, by the NEF, a traffic influence request for the Anycast IP address from the CATS-MUP-C, and updating, by the NEF and the UDR, a new PCC rule for the Anycast IP address and storing the new PCC rule.

The method may include: after the reconfiguration of the user plane path is completed, setting, by the SMF, a default value for a core network tunnel endpoint ID (TEID) and an N3 IP address; generating a session management context response using the optimal service contact instance IP address between the SMF and the AMF; transmitting, by the AMF, an N2 PDU session request to a radio access network (RAN) managing the base station; and completing the PDU session establishment between the RAN and the UE.

The method may include: after the completion of the PDU session establishment, transmitting, by the UE, initial uplink data to an egress CATS router through a segment routing tunnel; transmitting, by the RAN, the TEID of the base station to which the UE has accessed to the AMF; transferring, by the AMF, the TEID of the base station to the SMF; and exchanging, by the SMF and the CATS-MUP-C, session modification information including the TEID of the base station.

The method may include: after the exchanging the session modification information, transmitting, by the CATS-MUP-C, converted routing information for uplink and downlink paths to the ingress CATS router controlled by the CATS-MUP-C.

After the PDU session is completed, when the UE transmits a first packet destined for the Anycast IP address to the ingress CATS router, the ingress CATS router may confirm whether there is a routing rule for the Anycast IP address, and transmit a service request for the Anycast IP address to the CATS-MUP-C for service confirmation when there is no routing rule for the Anycast IP address, and the CATS-MUP-C may select an optimal service contact instance for transferring the user traffic using a CATS path selector (C-PS) function based on the location of the ingress CATS router.

According to another aspect of the present disclosure, there is provided a computing-aware traffic steering system in a mobile network, the computing-aware traffic steering system including: a control plane configured to transmit a service ID and user plane path information to a CATS mobile user plane controller (CATS-MUP-C) in a computing-aware traffic steering (CATS) network environment using segment routing in a case where it is confirmed that there is no target data network access identifier (DNAI) mapped to the service ID when a PDU session establishment request including the service ID of a user terminal (UE) is made, and reconfigure a user plane path to access an Anycast IP address corresponding to the service ID in conjunction with the CATS-MUP-C; and a data plane configured to transfer uplink data and downlink data between the UE and the optimal service contact instance selected by the CATS-MUP-C in conjunction with the CATS-MUP-C after completing the PDU session establishment using the Anycast IP address.

According to another aspect of the present disclosure, there is provided a user terminal connected to a mobile network system for computing-aware traffic steering, the user terminal including: a processor; and a memory connected to the processor, wherein the memory stores program commands executed by the processor to transmit a PDU session establishment request including a service ID to a mobile network control plane, and when it is confirmed that the control plane does not have a target data network access identifier (DNAI) mapped to the service ID, transmit the service ID and user plane path information to a CATS mobile user plane controller (CATS-MUP-C) in a computing-aware traffic steering (CATS) network environment using segment routing, and complete PDU session establishment with a radio access network (RAN) after reconstructing the user plane path to access the Anycast IP address corresponding to the service ID in conjunction with the CATS-MUP-C, and transmit, by the UE, the first packet destined for the Anycast IP address to the ingress CATS router controlled by the CATS-MUP-C after the PDU session is completed.

According to the present disclosure, there is an advantage in that user traffic of a user terminal connected to a mobile network can be dynamically steered to an optimal service contact instance.

### BRIEF DESCRIPTION OF DRAWINGS

FIGS. 1 and 2 illustrate a configuration of a mobile user plane (MUP) using segment routing.

FIG. 3 illustrates two types of paths in a case where path information for segment routing is obtained using a Border Gateway Protocol (BGP) routing protocol in an SR (Segment Routing)-MUP (Mobile User Plane) architecture.

FIG. 4 illustrates a case where multiple service instances are deployed in a fixed UPF (User Plane Function) environment.

FIG. 5 illustrates a case where a UPF dedicated to a service contact instance exists in a centralized CATS-supported mobile user plane architecture using SR.

FIG. 6 illustrates a bypass UPF mode in a centralized CATS-supported mobile user plane architecture using the SR.

FIG. 7 illustrates a communication protocol between CATS-MUP-C and an underlay network according to the present embodiment.

FIG. 8 illustrates a dynamic anycast mode in the centralized CATS-supported mobile user plane architecture using the SR according to the present embodiment.

FIG. 9 illustrates a communication protocol between the CATS-MUP-C and the underlay network in the dynamic anycast mode according to the present embodiment.

FIGS. 10A and 10B illustrate a CATS-based PDU session establishment request procedure in the dynamic anycast mode according to the present embodiment.

FIGS. 11A and 11B illustrate a process of completing PDU session establishment and transmitting initial uplink and downlink data in the dynamic anycast mode according to the present embodiment.

FIG. 12 illustrates a packet flow in a user plane according to the present embodiment.

FIG. 13 illustrates a configuration of a user terminal according to a preferred embodiment of the present disclosure.

### DETAILED DESCRIPTION

The present disclosure can be modified in various ways and can have various embodiments, and specific embodiments are illustrated in the drawings and described in detail in the detailed description. However, this is not intended to limit the present disclosure to specific embodiments, and should be understood to include all modifications, equivalents, or substitutes included in the spirit and technical scope of the present disclosure.

The terms used in the present specification are used only to describe specific embodiments, and are not intended to limit the present disclosure. The singular expression includes the plural expression unless the context clearly indicates otherwise. In the present specification, the terms “include” or “have” are intended to specify the presence of a feature, number, step, operation, component, part, or combination thereof described in the specification, and should be understood not to exclude in advance the possibility of the presence or addition of one or more other features, numbers, steps, operations, components, parts, or combinations thereof.

In addition, the components of the embodiments described with reference to each drawing are not limited to the corresponding embodiments, and may be implemented to be included in other embodiments within the scope that the technical idea of the present disclosure is maintained, and it is also obvious that multiple embodiments may be re-implemented as one embodiment that is integrated even if a separate description is omitted.

In addition, when describing with reference to the attached drawings, the same components are given the same or related reference symbols regardless of the drawing symbols, and redundant descriptions thereof are omitted. In describing the present disclosure, if it is judged that a specific description of a related known technology may unnecessarily obscure the gist of the present disclosure, a detailed description thereof is omitted.

In a mobile network according to the present embodiment, computing-aware traffic steering may be performed based on segment routing (SR).

Hereinafter, the segment routing will be described in detail, focusing on the mobile network being a 5G network.

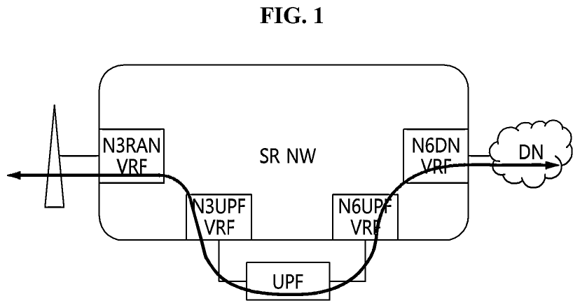

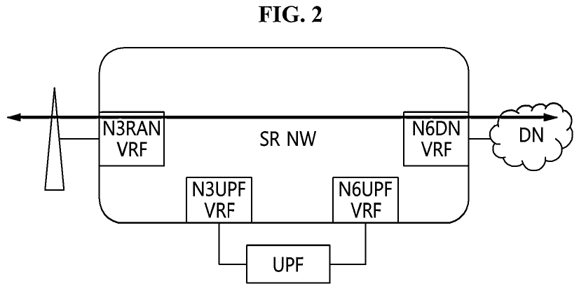

FIGS. 1 and 2 illustrate a mobile user plane (MUP) configured using the segment routing.

FIG. 1 illustrates a structure in which a PDU session is connected through an existing UPF in an SR underlay network.

Referring to FIG. 1, an existing 3GPP mobile network is connected to the SR underlay network without change.

Here, the SR underlay network may be an SRv6 underlay network.

This mode represents a structure in which a PDU session is connected through an existing UPF in an SR underlay network between two GTP-U (GPRS Tunnelling Protocol User Plane) tunnel endpoints, and the SR underlay network provides the connection.

FIG. 2 illustrates a structure in which a PDU session is directly connected between two GTP-U (GPRS Tunnelling Protocol User Plane) tunnel endpoints in an SR underlay network without using an existing UPF. Here, the SR underlay network provides the direct connection. This is named the SR-MUP architecture.

As illustrated in FIG. 2, using the SR-MUP architecture, an optimal path can be provided through the SRv6 underlay network without using a user plane function (UPF).

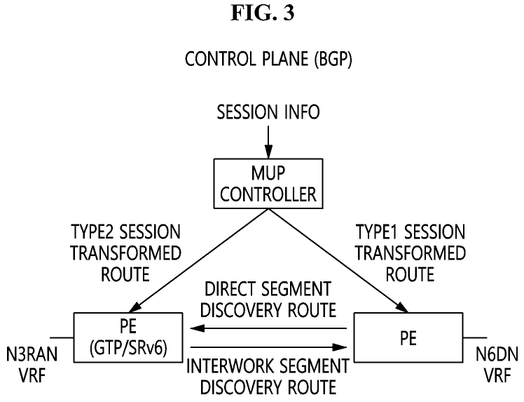

FIG. 3 illustrates two types of routes when obtaining route information for segment routing using a BGP (Border Gateway Protocol) routing protocol in the SR-MUP architecture.

Referring to FIG. 3, the route types for the SR-MUP architecture are as follows.

Interwork Segment Discovery route: PE (Provider Edge node in an SR network) advertises this route for N3 interface discovery connected to a radio access network (RAN).

Direct Segment Discovery route: PE advertises this route for N6 interface discovery on a data network (DN) side.

Moreover, in relation to the path setting on the segment routing network linked from the PDU session information of the 5G control plane in the SR-MUP architecture, a route (Type 1 session transformed route) transformed based on the information of Type 1 Session, which is a PDU session in a downlink direction, is set through MUP-C(Controller node for an SR network), and a route (Type 2 session transformed route) transformed based on the information of the Type 2 Session, which is a PDU session in an uplink direction, is set through the MUP-C.

In addition to a 5G traditional approach of a mobile user plane (IP-based underlay network), various solutions for the mobile user plane, such as SRv6 or LISP for the mobile user plane, are being discussed.

In the present embodiment, a method for transferring user traffic to distributed service instances through computing-aware traffic steering will be described in the following various cases for the 5G mobile user plane.

In the present embodiment, using SRv6 with segment routing through IPV6 for the mobile user plane will be focused.

In the following, a case where multiple service instances are deployed behind a fixed UPF, a case where a dedicated UPF mode exists in the centralized CATS-supported mobile user plane architecture using the segment routing, and a bypassing UPF mode in a centralized CATS-supported mobile user plane architecture using the segment routing will be mainly described.

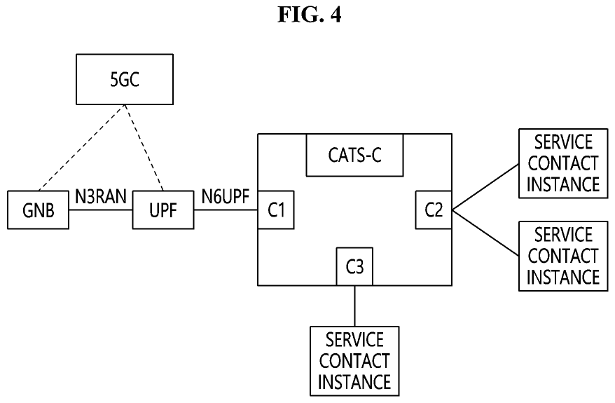

FIG. 4 illustrates a case where multiple service instances are deployed in a fixed UPF environment.

Referring to FIG. 4, multiple service contact instances are deployed behind the fixed UPF and are managed by a CATS-Controller (CAST-C).

The fixed UPF is defined as an ingress gateway for accessing one of multiple service contact instances through a CATS-C infrastructure network.

The fixed UPF is managed in a mobile network (for example, 5GC) control plane.

Whenever a user requests a given service with a service ID, the mobile network control plane selects the fixed UPF and establishes a packet data unit (PDU) session for User Equipment (UE).

Then, the UE sends user traffic through the fixed UPF, and the UPF transfers the user traffic to the ingress CATS router C1, and a CATS-C framework is responsible for computing-aware traffic steering for an optimal service contact instance IP.

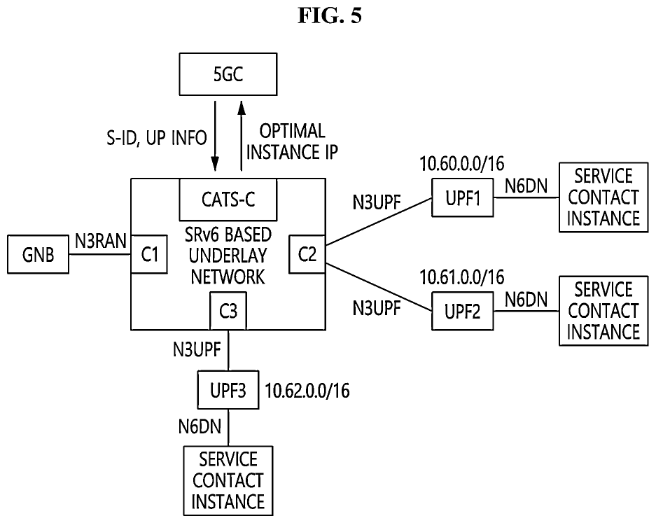

FIG. 5 illustrates a case where the UPF dedicated to the service contact instance exists in the centralized CATS-supported mobile user plane architecture using the SR.

Referring to FIG. 5, multiple dedicated UPFs (UPF 1 to UPF 3) for multiple service contact instances are deployed at geographically distributed edge sites and connected to a segment routing-based underlay network (SRv6 underlay network).

A user traffic to move to a specific service contact instance should first go through a dedicated UPF, and one UPF is dedicated to one service contact instance (for example, MEC case).

The SRv6 underlay network is conjunction with the mobile user plane architecture and does not require any changes to the existing 3GPP mobile network.

Service confirmation for mobile user traffic is handled by a centralized CATS-C via the mobile network control plane.

The CATS-C manages computing and networking metrics, supports communication with the mobile network control plane for traffic steering to the optimal service contact instance, and functions as the SRv6 underlay network control.

In the SRv6 underlay network, the ingress CATS router C1 and the egress CATS router C2 are also SRv6-aware nodes and are deployed with CATS functionality. The egress CATS router C2 acts as an SR gateway and can be aware of one or more UPFs via a segment routing identifier (SID) operation endpoint for the corresponding UPF interface.

In addition, the ingress CATS router C1 acts as an SR gateway using the SID operation endpoint for the gNB interface.

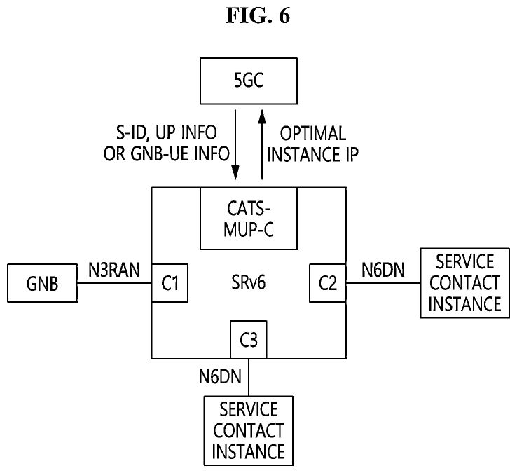

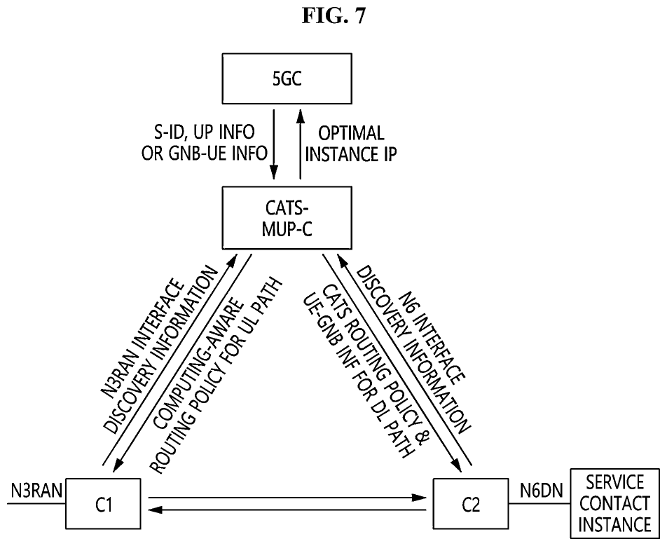

FIG. 6 illustrates a bypass UPF mode in a centralized CATS-supported mobile user plane architecture using the SR, and FIG. 7 illustrates a communication protocol between CATS-MUP-C and an underlay network according to the present embodiment.

Referring to FIGS. 6 and 7, in the bypass UPF mode in the centralized CATS-supported mobile user plane architecture, the service contact instance is not deployed behind the UPF, but is directly connected to the SRv6-based underlay network.

In the bypass UPF mode, the CATS-MUP-C is an MUP-C with a CATS controller function.

Here, the CATS-MUP-C communicates with 5G control plane to receive SID, UP information or gNB-UE information from 5GC, and transfers the optimal service contact instance IP address to 5G control plane to allow direct path between the UE and the target service contact instance without UPF intervention.

In this case, user traffic to move to a specific service contact instance does not need to go through UPF and can go directly to the service contact instance through the SRv6 underlay network.

With MUP function, the CATS-MUP-C converts session information into routing information and then injects the SRv6 routing policy to the corresponding ingress and egress CATS routers.

In addition, the CATS-MUP-C is responsible for communicating with the 5G control plane to find the optimal service contact instance IP address based on the computing and networking metrics and the UE-gNB location.

In an underlay network infrastructure, the ingress CATS router C1 and the egress CATS router C2 are also the SRv6 aware nodes and are deployed with the CATS function.

The egress CATS router C2 acts as an SR gateway that can recognize one or more service contact instances through the SID operation endpoint using the corresponding interface.

In addition, the ingress CATS router C1 acts as the SR gateway using the SID operation endpoint for the gNB interface.

More specifically, referring to FIG. 7, in the SR-MUP architecture conjunction with the 5G control plane, the PE can connect to the N6 interface on the DN side, and the N6 interface search path for the DN is advertised from the PE to the CATS-MUP-C with the corresponding SID.

The N3 RAN interface search path for the N3 network that accommodates the RAN is advertised from the PE to the CATS-MUP-C with the RAN segment SID.

The CATS-MUP-C selects the optimal computing instance and the contact instance for the optimal computing instance based on the session information requested from the 5G control plane, determines the path to the instance, and then advertises the corresponding routing policy to the segment routing domain.

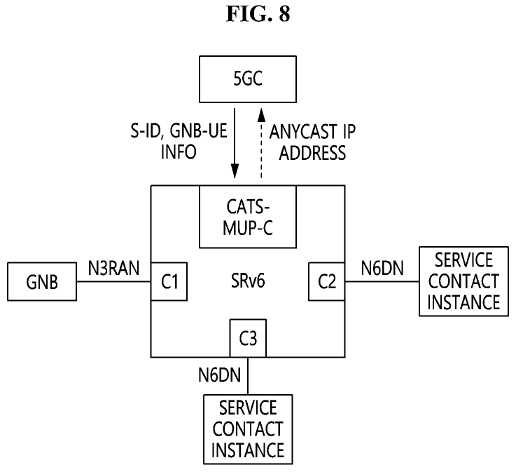

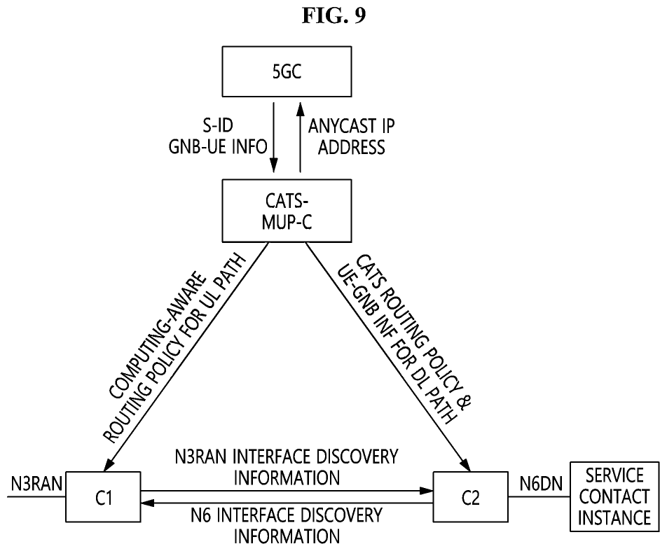

FIG. 8 illustrates a dynamic anycast mode in the centralized CATS-supported mobile user plane architecture using the SR according to the present embodiment, and FIG. 9 illustrates a communication protocol between the CATS-MUP-C and the underlay network in the dynamic anycast mode according to the present embodiment.

FIGS. 8 and 9 illustrate that there is no UPF, and the CATS-MUP-C communicates with the 5G control plane, allowing a direct path between the UE and the target service contact instance without UPF intervention.

The difference with the UPF bypass mode is that CATS-based service identification for mobile user traffic no longer depends on the 5G control plane, but is handled on the user data plane via the ingress CATS router and CATS-MUP-C.

The dynamic anycast mode involves two steps. First, after the PDU session establishment is made using the Anycast IP address of the service, the UE transmits a service request to the ingress CATS router C1 using the Anycast IP address, C1 requests computing-aware traffic steering to the CATS-MUP-C, and at this time, C1 requests computing-aware traffic steering via the integrated CATS path selector (C-PS) function.

In the 5G architecture, the PDU session is used to provide end-to-end user plane connectivity between the UE and a specific data network (DN).

However, in the dynamic anycast mode according to the present embodiment, the PDU session establishment using the Anycast IP address of the service is different from the PDU session establishment in the existing 5G architecture.

Here, the Anycast IP address is a network address for various service instances executed in various locations.

The user plane path between the UE and the ingress CATS router is reconfigured through the PDU session using the Anycast IP address instead of a specific data network.

Then, the ingress CATS router confirms the target destination and transfers the user traffic to the optimal service contact instance. The service may be known to the 5G operator or may be distributed in the general Internet domain.

Therefore, the Anycast IP address may be managed within the 5G mobile network domain or managed by the Anycast management server located outside the 5G network domain. The method of configuring the PDU session establishment using the Anycast IP address is divided into two methods depending on the operator's distribution method.

In the first method, when the service is located in the mobile network domain and the Anycast IP address of the service is managed by the mobile operator, the 5G control plane may directly establish PDU sessions using the Anycast IP address without asking third-party services deployed outside the mobile network domain.

For example, the mobile network operator may deploy the network by integrating with a LISP-based service ID management system that provides uniform access to equivalent services executed on different edge clouds.

The LISP control plane defines and manages the service IDs for the same service based on a mapping system of the service ID and the corresponding locators.

In this way, the 5G control plane may determine the Anycast IP address for the same service through the LISP-based service ID.

A single service ID can act directly as an Anycast IP address or be a part of an Anycast service IP address, depending on the mobile operator mechanism.

Finally, the 5G control plane may directly perform the PDU session establishment using the known Anycast IP address.

The second way is that when the service is in the Internet domain, the CATS-MUP-C may query this information, and whenever the PDU session using the Anycast IP address is to be established, the 5G control plane requests the requested Anycast IP address to the CATS-MUP-C.

Referring to FIG. 9, in the dynamic anycast mode according to the present embodiment, the PE can connect to the N6 interface on the DN side in the SR-MUP architecture conjunction with the 5G control plane, and the N6 interface search path for the DN is advertised from the PE to the ingress CATS router C1 along with the corresponding SID.

The N3 RAN interface search path for the N3 network that accommodates the RAN is advertised from the PE to the egress CATS router C2 along with the RAN segment SID.

Based on the session information requested from the 5G control plane, the CATS-MUP-C selects the optimal compute instance and the contact instance for the optimal computing instance, determines the path to the instance, and then advertises the corresponding routing policy to the segment routing domain.

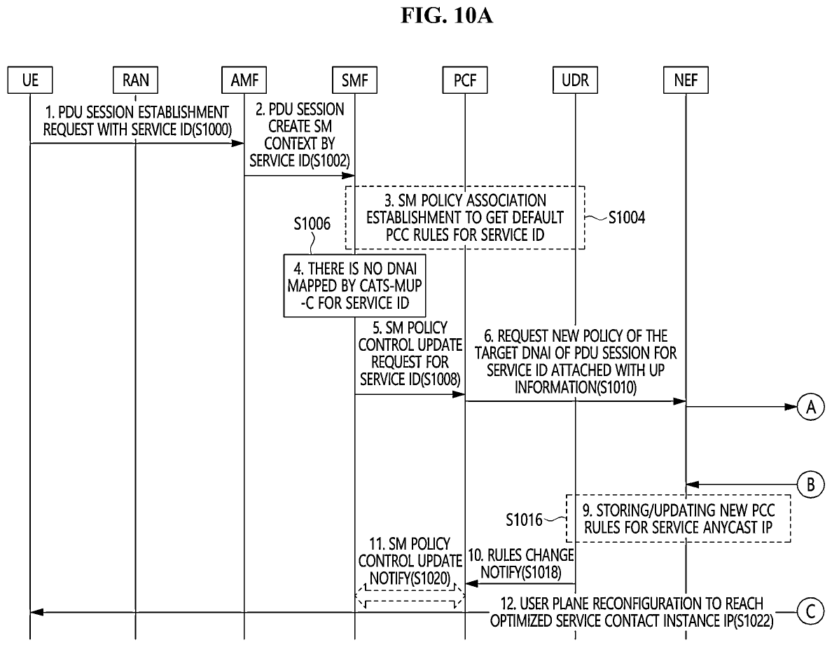

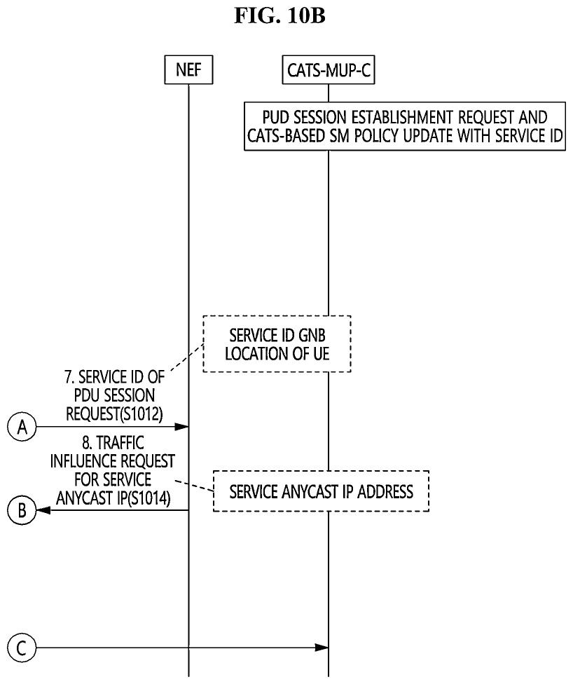

FIGS. 10A and 10B illustrate a CATS-based PDU session establishment request procedure in dynamic anycast mode according to the present embodiment.

Whenever the UE joins a mobile network, the UE transmits the PDU session establishment request with the service ID to an access and mobility management function (AMF) (Step 1000). At this time, the AMF manages the mobility of the UE location.

In response to each request type, the AMF calls a PDU session create SM context request to the corresponding session management function (SMF) according to a data network name (DNN) corresponding to the service ID requested by the UE (Step 1002).

The SMF performs a SM policy association establishment procedure to establish SM policy association with a policy control function (PCF) in conjunction with unified data repository (UDR) and obtain a default policy and charging control (PCC) rule for service ID (Step 1004).

The PCC rule includes traffic identification information, target data network access identifier (DNAI) information, and/or N6 traffic routing information.

The UDR is a 5G network solution that provides data storage and query function to 5G network function (NF).

When it is confirmed that there is no target DNAI mapped to the service ID by CATS-MUP-C(Step 1006), the SMF transmits a message including target DNAI of PDU session and user plane path information to CATS-MUP-C(Steps 1008 to 1012).

Here, the user plane path information may be path information set as default to access a site corresponding to the service ID.

In Step 1008, a SM policy control update request for service ID is transmitted to the PCF.

Afterwards, in Step 1010, the PCF requests a new policy for the target DNAI of the PDU session for the service ID to which the user plane path information attached to a network exposure function (NEF).

In Step 1012, the NEF transmits the service ID of the PDU session establishment request to the CATS-MUP-C.

As in Steps 1008 to 1012, the SMF may send a message including the target DNAI of the PDU session and user plane path information through the PCF, and then move to the CATS-MUP-C through the network exposure function (NEF).

Next, the CATS-MUP-C transmits the traffic influence request for Anycast IP address of the service to the NEF (Step 1014).

In the dedicated UPF or UPF bypassing, the CATS controller calculates the optimal service contact instance IP address based on the Anycast IP address, the location of the gNB connected to the UE, and computing and networking metrics. However, in the dynamic anycast mode according to the present embodiment, this process is not performed, and the CATS-MUP-C transmits the traffic influence request for the Anycast IP address of the service to the NEF.

The NEF and UDR update a new PCC rule for the Anycast IP address (a new PCC rule that changes the user plane path) and store the new PCC rule (Step 1016).

The PCF receives a rule change notification regarding the user plane path change from the UDR (Step 1018).

The PCF transmits an SM policy rule update notification to the SMF (Step 1020), and the SMF takes appropriate action to reconfigure the user plane path of the PDU session (Step 1022).

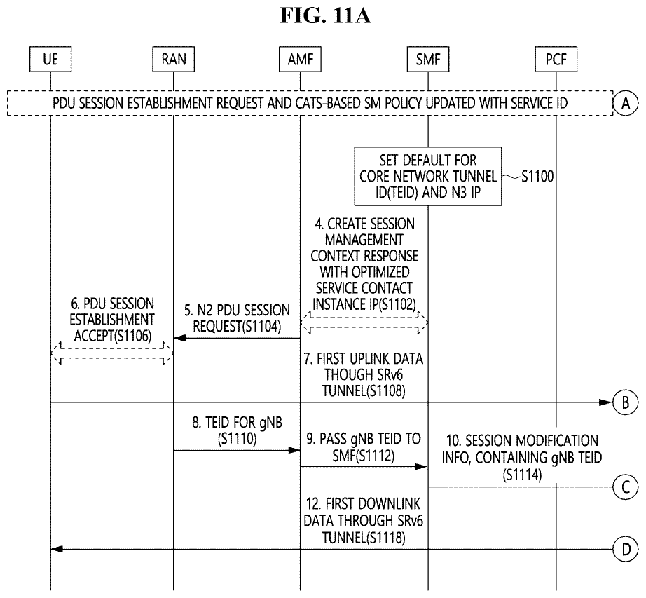

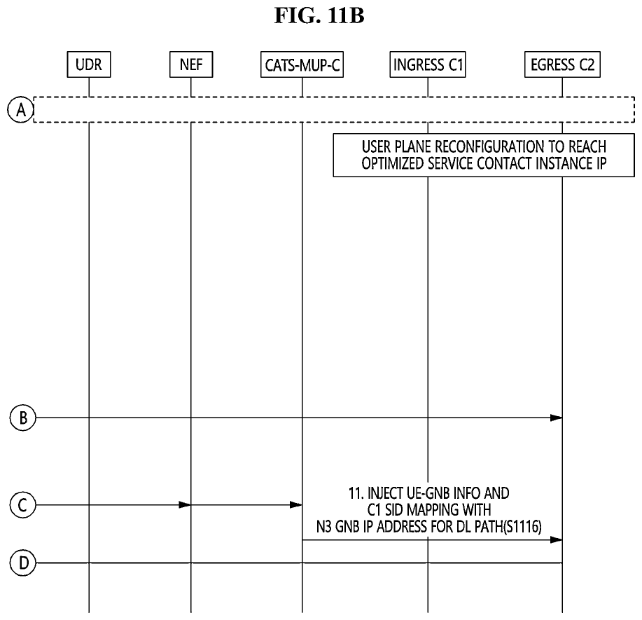

FIGS. 11A and 11B illustrate the process after the user plane path reconfiguration for accessing the optimal service contact instance IP address in the dynamic anycast mode according to the present embodiment.

In the dynamic anycast mode, the CATS-MUP-C waits until the PDU session establishment is successful to receive the UE session information such as the UPF TEID and the UE-gNB information, which is an essential parameter for both uplink and downlink traffic, and then the CAT-MUP-C notifies the corresponding ingress CATS router C1 of the converted routing information based on the UE-gNB location.

Referring to FIGS. 11A and 11B, after the user plane path reconfiguration is completed, the SMF sets the default values for the core network tunnel endpoint ID (TEID) and the N3 IP address (Step 1100).

After Step 1100, a session management context response using the optimal service contact instance IP address is generated between the SMF and the AMF (Step 1102).

The AMF transmits the N2 PDU session request to the RAN (Step 1104).

After that, the PDU session establishment is performed between the RAN and the UE (Step 1106).

After the session establishment, the UE transmits initial uplink data to the egress CATS router C2 through the SRv6 tunnel (Step 1108).

The RAN transmits the gNB TEID to the AMF (Step 1110), and the AMF transfers the gNB TEID to the SMF (Step 1112).

Next, the SMF and the CATS-MUP-C exchange session modification information including the gNB TEID (Step 1114).

After exchanging the session modification information in Step 1114, the CATS-MUP-C transmits UE-gNB information for downlink path and C1 SID mapping information using N3 gNB IP address to the egress CATS router C2 (Step 1116).

After that, the egress CATS router C2 transmits initial downlink data to the UE through SRv6 tunnel (Step 1118).

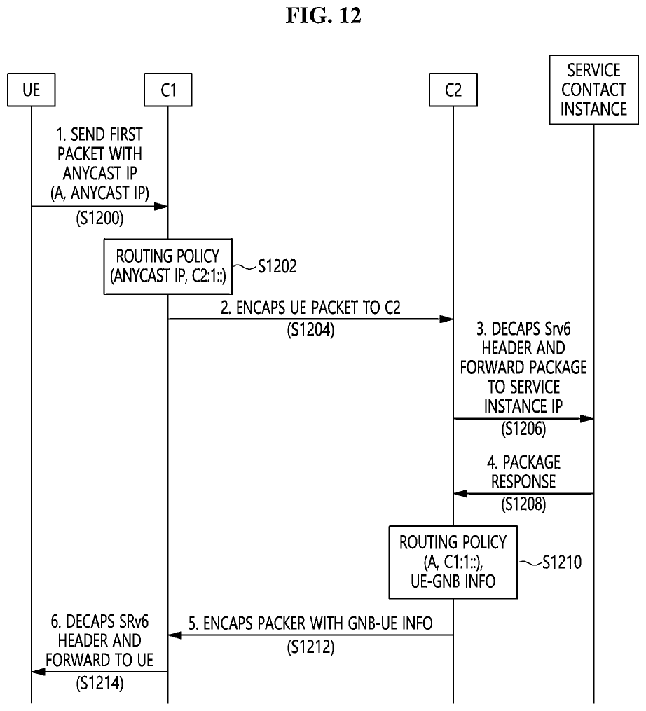

FIG. 12 illustrates a packet flow for the user data plane procedure in the dynamic anycast mode.

FIG. 12 describes the first packet flow from the UE to the target service contact instance flow in the dynamic anycast mode.

When the UE transmits a packet destined for destination Z (Anycast IP address) to the gNB, the gNB encapsulates the packet with the GTP-U header and transmits the packet to the ingress CATS router C1 (Default IPv6 (predefined)) (Step 1200).

C1 checks the routing policy (Anycast IP, C2: 1::) (Step 1202), removes the GTP-U header according to the routing policy, pushes the SRv6 header, and transmits the SRv6 header to the egress CATS router (Step 1204).

When the packet arrives at C2, C2 removes the SRv6 header, and transfers the packet with the SRv6 header removed to the target service contact instance (Step 1206).

When C2 receives a packet response from the service contact instance (Step 1208), according to the routing policy (A, C1: 1::), C2 pushes the SRv6 header to C1: 1:: TEID using the IP of the gNB as the last SID and the TEID as a parameter (Step 1210), and transfers the SRv6 header to C1 (Step 1212).

C1 receives the packet, removes the SRv6 header, generates a new GTP header in the gNB IP (the last SID of the SRv6 header), and transmits the gNB response packet to the UE (Step 1214).

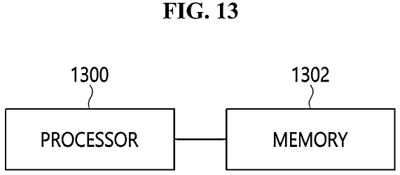

FIG. 13 illustrates a configuration of a user terminal according to a preferred embodiment of the present disclosure.

As illustrated in FIG. 13, a user terminal (UE) according to the present embodiment may include a processor 1300 and a memory 1302.

Here, the processor 1300 may include a central processing unit (CPU) capable of executing a computer program or a virtual machine, or the like.

The memory 1302 may include a nonvolatile storage apparatus such as a fixed hard drive or a removable storage apparatus. The removable storage apparatus may include a compact flash unit, a USB memory stick, or the like. The memory 1302 may also include a volatile memory such as various random access memories, and may be defined as a computer-readable recording medium.

The memory 1302 according to the present embodiment stores program commands that allow a user terminal connected to a mobile network to request the PDU session establishment using the service ID and access the optimal contact instance corresponding to the service ID.

The program commands according to the present embodiment transmit the PDU session establishment request including the service ID to the mobile network control plane, and when it is confirmed that the control plane does not have the target data network access identifier (DNAI) mapped to the service ID, transmit the service ID and user plane path information to a CATS mobile user plane controller (CATS-MUP-C) in a computing-aware traffic steering (CATS) network environment using segment routing, and complete PDU session establishment with a radio access network (RAN) after reconstructing the user plane path to access the Anycast IP address corresponding to the service ID in conjunction with the CATS-MUP-C, and transmit, by the UE, the first packet destined for the Anycast IP address to the ingress CATS router controlled by the CATS-MUP-C after the PDU session is completed.

The above-described embodiments of the present disclosure have been disclosed for the purpose of illustration, and those skilled in the art having common knowledge of the present disclosure will be able to make various modifications, changes, and additions within the spirit and scope of the present disclosure, and such modifications, changes, and additions should be considered to fall within the scope of the following claims.

What is claimed is:

1. A computing-aware traffic steering method of mobile network control plane, the method comprising:
in a case where it is confirmed that there is no target data network access identifier (DNAI) mapped to a service ID when a packet data unit (PDU) session establishment request including the service ID of a user terminal (UE) is made, transmitting the service ID and user plane path information to a computing-aware traffic steering mobile user plane controller (CATS-MUP-C) in a computing-aware traffic steering (CATS) network environment using segment routing;
reconfiguring a user plane path for accessing an Anycast IP address corresponding to the service ID in conjunction with the CATS-MUP-C; and
completing a PDU session establishment using the Anycast IP address.

2. The method of claim 1, wherein the mobile network control plane is a control plane of a 5G or 6G mobile communication network, and
the transmitting includes calling a PDU session create session management (SM) context request to a corresponding session management function (SMF) according to a data network name (DNN) corresponding to the service ID when an access and mobility management function (AMF) of the control plane receives the PDU session establishment request from the UE.

3. The method of claim 2, wherein the transmitting includes, after the calling, performing an SM policy association establishment procedure so that the SMF establishes an SM policy association with a policy control function (PCF) in conjunction with unified data repository (UDR) and obtains a default policy and charging control (PCC) rule for the service ID.

4. The method of claim 3, wherein the PCC rule includes traffic identification information, the target data network access identifier (DNAI) information, and/or N6 traffic routing information.

5. The method of claim 4, wherein the transmitting includes, after the performing of the SM policy association establishment procedure, transmitting a SM policy control update request for the service ID to the PCF when the SMF confirms that there is no target DNAI mapped to the service ID by the CATS-MUP-C.

6. The method of claim 5, wherein the transmitting includes, after the transmitting of the SM policy control update request, requesting, by the PCF, a new policy of the target DNAI of the PDU session establishment request for the service ID to which the user plane path information is attached to a network exposure function (NEF).

7. The method of claim 6, wherein the transmitting includes, after the requesting of a new policy of the target DNAI of the PDU session establishment request, transmitting, by the NEF, the service ID to the CATS-MUP-C.

8. The method of claim 7, wherein the reconfiguring of the user plane path includes:
receiving, by the NEF, a traffic influence request for the Anycast IP address from the CATS-MUP-C, and
updating, by the NEF and the UDR, a new PCC rule for the Anycast IP address and storing the new PCC rule.

9. The method of claim 8, comprising:
after the reconfiguration of the user plane path is completed, setting, by the SMF, a default value for a core network tunnel endpoint ID (TEID) and an N3 IP address;
generating a session management context response using an optimal service contact instance IP address between the SMF and the AMF;
transmitting, by the AMF, an N2 PDU session request to a radio access network (RAN) managing the base station; and
completing the PDU session establishment between the RAN and the UE.

10. The method of claim 9, comprising:
after the completion of the PDU session establishment, transmitting, by the UE, initial uplink data to an egress CATS router through a segment routing tunnel;
transmitting, by the RAN, the TEID of the base station to which the UE has accessed to the AMF;
transferring, by the AMF, the TEID of the base station to the SMF; and
exchanging, by the SMF and the CATS-MUP-C, session modification information including the TEID of the base station.

11. The method of claim 10, comprising, after exchanging the session modification information, transmitting, by the CATS-MUP-C, converted routing information for uplink and downlink paths to an ingress CATS router controlled by the CATS-MUP-C.

12. The method of claim 11, wherein after the PDU session establishment is completed, when the UE transmits a first packet destined for the Anycast IP address to the ingress CATS router, the ingress CATS router confirms whether there is a routing rule for the Anycast IP address, and transmits a service request for the Anycast IP address to the CATS-MUP-C for service confirmation when there is no routing rule for the Anycast IP address, and the CATS-MUP-C selects an optimal service contact instance for transferring the user traffic using a CATS path selector (C-PS) function based on the location of the ingress CATS router.

13. A computing-aware traffic steering system in a mobile network, the computing-aware traffic steering system comprising:
a control plane configured to transmit a service ID and user plane path information to a computing-aware traffic steering mobile user plane controller (CATS-MUP-C) in a computing-aware traffic steering (CATS) network environment using segment routing in a case where it is confirmed that there is no target data network access identifier (DNAI) mapped to the service ID when a packet data unit (PDU) session establishment request including the service ID of a user terminal (UE) is made, and reconfigure a user plane path to access an Anycast IP address corresponding to the service ID in conjunction with the CATS-MUP-C; and
a data plane configured to transfer uplink data and downlink data between the UE and an optimal service contact instance selected by the CATS-MUP-C in conjunction with the CATS-MUP-C after completing an PDU session establishment using the Anycast IP address.

14. The computing-aware traffic steering system of claim 13, wherein the control plane includes:
an access and mobility management function (AMF) configured to call PDU session create session management (SM) context request according to a data network name (DNN) corresponding to the service ID when receiving the PDU session establishment request from the UE, and
a session management function (SMF) called by the AMF and configured to perform an SM policy association establishment procedure to establish an SM policy association with a policy control function (PCF) in conjunction with a unified data repository (UDR) and obtain a default policy and charging control (PCC) rule for the service ID.

15. The computing-aware traffic steering system of claim 14, wherein when it is confirmed that there is no target DNAI mapped to the service ID by the CATS-MUP-C, the SMF transmits an SM policy control update request for the service ID to the PCF, and the PCF requests a new policy of the target DNAI of the PDU session establishment request for the service ID to which the user plane path information is attached to a network exposure function (NEF).

16. The computing-aware traffic steering system of claim 15, wherein when the UE transmits a first packet destined for the Anycast IP address to an ingress CATS router controlled by the CATS-MUP-C after the PDU session establishment is completed, the ingress CATS router confirms whether there is a routing rule for the Anycast IP address, and when there is no routing rule for the Anycast IP address, transmits a service request for the Anycast IP address to the CATS-MUP-C for service confirmation, and the CATS-MUP-C selects the optimal service contact instance for transferring user traffic using a CATS path selector (C-PS) function based on the location of the ingress CATS router.

17. A user terminal connected to a mobile network system for computing-aware traffic steering, the user terminal comprising:
a processor; and
a memory connected to the processor,
wherein the memory stores program commands executed by the processor to
transmit a packet data unit (PDU) session establishment request including a service ID to a mobile network control plane, and
when it is confirmed that the mobile network control plane does not have a target data network access identifier (DNAI) mapped to the service ID, transmit the service ID and user plane path information to a computing-aware traffic steering mobile user plane controller (CATS-MUP-C) in a computing-aware traffic steering (CATS) network environment using segment routing, and complete a PDU session establishment with a radio access network (RAN) after reconstructing a user plane path to access an Anycast IP address corresponding to the service ID in conjunction with the CATS-MUP-C, and
transmit, by a user terminal (UE), a first packet destined for the Anycast IP address to an ingress CATS router controlled by the CATS-MUP-C after the PDU session establishment is completed.

18. The user terminal of claim 17, wherein the ingress CATS router confirms whether there is a routing rule for the Anycast IP address, and when there is no routing rule for the Anycast IP address, the ingress CATS router transmits a service request for the Anycast IP address to the CATS-MUP-C for service confirmation, and the CATS-MUP-C selects an optimal service contact instance for transferring user traffic using a CATS path selector (C-PS) function based on the location of the ingress CATS router.
